(19) United States
(12) Patent Application Publication
(10) Pub. No.: US 2023/0054715 A1
(43) Pub. Date: Feb. 23, 2023

(54) Methods And System Of Frequency Synchronization Mechanisms For Integration Of Terrestrial Network And Non-Terrestrial network Communications

(71) Applicant: MediaTek Singapore Pte. Ltd., Singapore (SG)

(72) Inventors: Dan Li, Shanghai (CN); Shiang-Jiun Lin, Hsinchu City (TW); I-Kang Fu, Hsinchu City (TW); Xuancheng Zhu, Shanghai (CN)

(21) Appl. No.: 17/796,556

(22) PCT Filed: Feb. 18, 2021
(86) PCT No.: PCT/CN2021/076682

§ 371 Date: Jul. 29, 2022

Related U.S. Application Data
(63) Continuation-in-part of application No. PCT/CN2020/075687, filed on Feb. 18, 2020.

(30) Foreign Application Priority Data
Feb. 18, 2020 (CN) PCT/CN2020/075687

(51) Int. Cl. H04B 7/01; H04B 7/212; H04B 7/185

(52) U.S. Cl. CPC H04B 7/01; H04B 7/2125; H04B 7/1855

(57) ABSTRACT

32 The present disclosure proposes schemes, techniques, designs and methods pertaining to frequency synchronization for integration of terrestrial network (TN) and non-terrestrial network (NTN) communications. Communications between a user equipment (UE) and a terrestrial network (TN) and communications between the UE and a non-terrestrial network (NTN) are established. A frequency shift in the communications between the UE and the NTN is compensated regardless of availability of information related to a movement of the UE and a relative location of the NT network node of the NTN with respect to the UE.

### CROSS REFERENCE TO RELATED PATENT APPLICATIONS

The present disclosure is part of U.S. National Stage filing of International Patent Application No. PCT/CN2021/076682, filed on 18 Feb. 2021, which claims the priority benefit of International Patent Application No. PCT/CN2020/075687, filed on 18 Feb. 2020, the contents of which being herein incorporated by reference in their entirety.

### FIELD OF THE INVENTION

The present disclosure is generally related to wireless communications and, more particularly, to frequency synchronization for integration of terrestrial network (TN) and non-terrestrial network (NTN) communications.

### BACKGROUND OF THE INVENTION

Unless otherwise indicated herein, approaches described in this section are not prior art to the claims listed below and are not admitted as prior art by inclusion in this section.

The convergence of NTN communication and TN communication is a way of providing global network coverage. NTN communications can supplement TNs wherever necessary. Additionally, NTNs can provide communication services in areas where there is no TN services, such as oceans, deserts, mountains and high altitudes. In addition, NTN communications can also be used as a backup solution for TNs. When TN services are unavailable for some reason, a terminal (herein interchangeably referred to as a user equipment (UE)) can attempt to communicate through an NTN.

Regarding the integration of NTN communication and TN communication, the same communication architecture and the same waveform can be used. Through lower-layer integration of the communication systems, development cost of terminals/UEs and base stations can be greatly reduced. Take terminal development as an example, the integration scheme of NTN communication and TN communication allows usage of a chip in terrestrial and non-terrestrial network communications. Compared with the need for two sets of equipment for individual support, the cost of a terminal can thus be reduced.

However, due to differences in physical characteristics in signal frequency offset and time delay, there tends to be a greater signal frequency shift in NTN communications compared to that in TN communications. There is, therefore, a need for a frequency synchronization mechanism for integrating TN and NTN communications.

### SUMMARY OF THE INVENTION

The following summary is illustrative only and is not intended to be limiting in any way. That is, the following summary is provided to introduce concepts, highlights, benefits and advantages of the novel and non-obvious techniques described herein.

Select implementations are further described below in the detailed description. Thus, the following summary is not intended to identify essential features of the claimed subject matter, nor is it intended for use in determining the scope of the claimed subject matter.

An objective of the present disclosure aims to provide schemes, solutions, concepts, designs, methods and systems to address aforementioned issue associated with difference in signal frequency shift between NTN communications and TN communications. Specifically, various proposed schemes in accordance with the present disclosure aim to provide a frequency synchronization mechanism for integrating TN and NTN communications. More specifically, the proposed frequency synchronization mechanism may support UEs with or without relative location information and moving information of the UE and network node(s) of TN and NTN networks.

In one aspect, a method may involve establishing communications between a UE and a base station (BS) of a TN and communications between the UE and a non-terrestrial (NT) network node of an NTN. The method may also involve compensating for a frequency shift in the communications between the UE and the NTN regardless of availability of information related to a movement of the UE and a relative location of a network node of the NTN with respect to the UE.

In another aspect, an apparatus implementable in a user equipment (UE) may comprise a transceiver and a processor coupled to the transceiver. The processor may be configured to perform operations comprising: establishing, via the transceiver, communications with a BS of a TN; establishing, via the transceiver, communications with a NT network node of an NTN; and compensating for a frequency shift in the communications between the UE and the NTN regardless of availability of information Attorney Docket No.: MDTK.0522US related to a movement of the UE and a relative location of the NT network node with respect to the UE.

It is noteworthy that, although description provided herein may be in the context of certain radio access technologies, networks and network topologies such as narrowband Internet of Things (NB-loT) and NTN, the proposed concepts, schemes and any variation(s)/derivative(s) thereof may be implemented in, for and by other types of radio access technologies, networks and network topologies, for example and without limitation, 5th Generation (5G) and New Radio (NR), Long-Term Evolution (LTE), LTE-Advanced, LTE-Advanced Pro, Internet of Things (loT) and Industrial Internet of Things (IloT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of a communication environment including a terminal supporting TN communication and NTN communication in accordance with various implementations of the present disclosure.

FIG. 2 is a diagram of an example scenario of Doppler frequency shift associated with a low-Earth-orbit (LEO) satellite.

FIG. 3 is a diagram of an example scenario of common propagation delay and differential propagation delay of an LEO satellite.

FIG. 4 is a diagram of an example scenario of residual Doppler frequency shift after pre-compensation of the Doppler frequency shift associated with the LEO satellite.

FIG. 5 is a diagram of an example scenario of downlink (DL) and uplink (UL) frequency error compositions without any compensation in a mobile communication system.

FIG. 6 is a diagram of an example scenario of common Doppler frequency shift pre-compensation using a frequency synchronization mechanism in accordance with the present disclosure.

FIG. 7 is a block diagram of an example communication system in accordance with an implementation of the present disclosure.

FIG. 8 is a flowchart of an example process in accordance with an implementation of the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

Overview

Implementations in accordance with the present disclosure relate to various techniques, methods, schemes and/or solutions pertaining to timing handling for integration of TN and NTN communications. According to the present disclosure, a number of possible solutions may be implemented separately or jointly. That is, although these possible solutions may be described below separately, two or more of these possible solutions may be implemented in one combination or another.

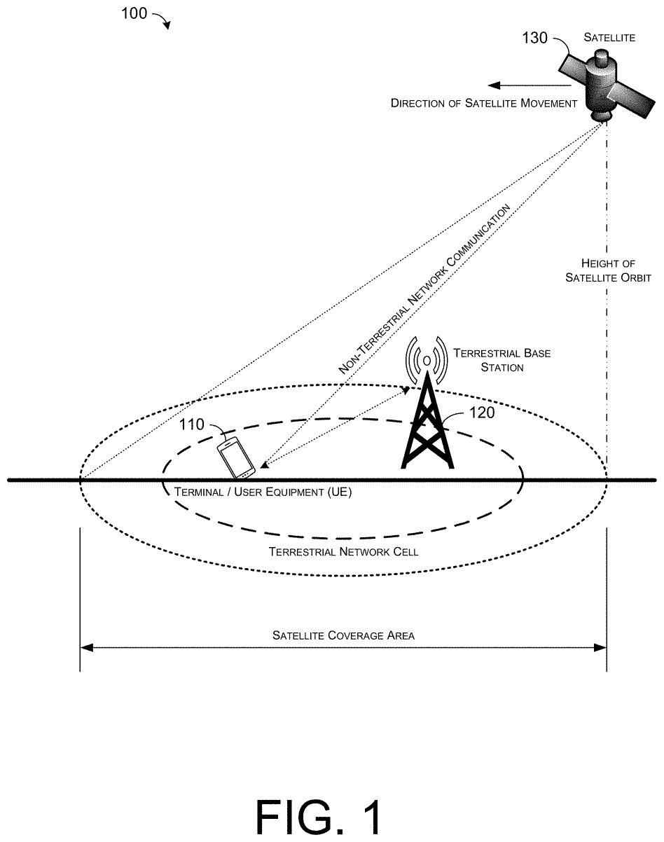

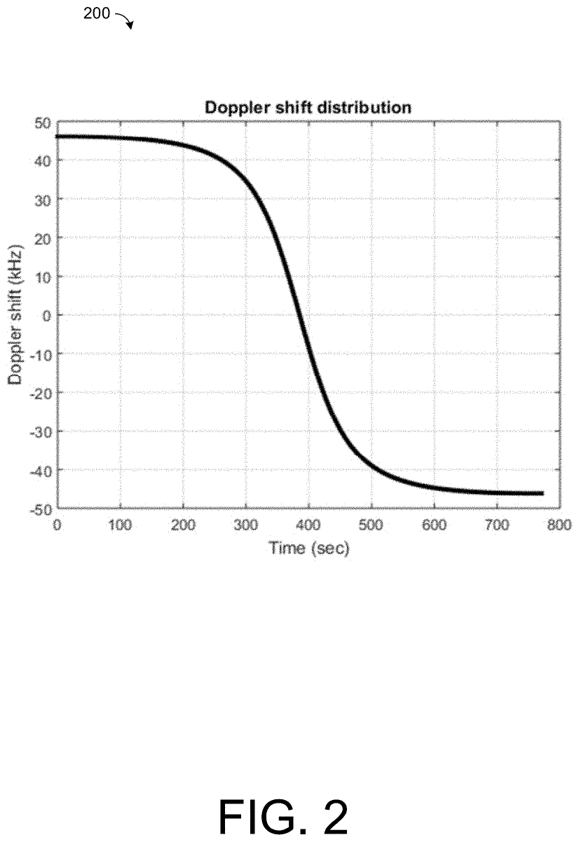

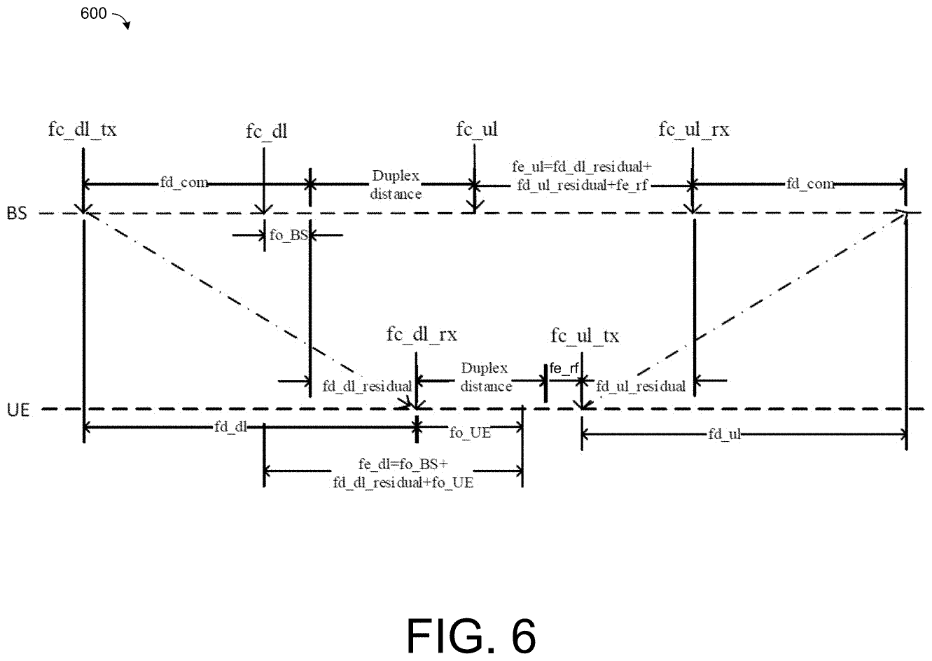

FIG. 1 illustrates an example communication environment 100 in accordance with various implementations of the present disclosure. FIG. 2 ˜ FIG. 6 illustrate examples related to proposed schemes and various implementations of the present disclosure. The following description of various proposed schemes of the present disclosure is provided with reference to FIG. 1 ˜ FIG. 6.

Referring to FIG. 1, communication environment 100 may involve a terminal or UE 110 supporting TN communication and NTN communication. UE 110 may be in communication with a terrestrial network node or base station (BS) 120 of a TN (not shown), such as a public land mobile network (PLMN), and a satellite 130 as a non-terrestrial (NT) network node of an NTN (not shown). BS 120 may be a network node of TN, and satellite 130 may be a network node of the NTN. That is, BS 120 may be considered as a terrestrial network node and satellite 130 may be considered as a non-terrestrial network node. BS 120 may be a gNB, eNB or transmission and reception point (TRP). Satellite 130 may be a low-orbit satellite that orbits the Earth at an altitude of 600 kilometers (km) above the ground. Moreover, the speed of satellite 130 may be 7.56 km per second (km/s), for example. In communication environment 100, each of UE 110, BS 120 and satellite 130 may be configured to implement various schemes pertaining to timing handling for integration of TN and NTN communications in accordance with the present disclosure, as described below.

It is noteworthy that, according to some embodiments of the present disclosure, the term “fo_BS” denotes a base statin oscillator error; the term “fo_UE” denotes a UE oscillator error; the term “fc_dl” denotes a DL reference frequency; the term “fc_ul” denotes a DL reference frequency; the term “fd_dl” denotes a DL actual Doppler frequency shift; the term “fd_ul” denotes an UL actual Doppler frequency shift; the term “fe_dl” denotes a DL total frequency error; the term “fe_ul” denotes an UL total frequency error; the term “fc_dl_tx” denotes a DL actual transmitted frequency; the term “fc_dl_rx” denotes a DL actual received frequency; the term “fc_ul_tx” denotes an UL actual transmitted frequency; the term “fc_ul_rx” denotes an UL actual received frequency; the term “fe_rf” denotes a frequency error of UE radio frequency (RF); and the term “fc_dl_est” denotes a value of fc_dl after DL synchronization. Moreover, the term “fd_com” denotes a pre-compensation Doppler frequency shift in beam center by a satellite (e.g., satellite 130); the term “fd_dl_residual” denotes a DL residual Doppler frequency shift; and the term “fd_ul_residual” denotes an UL residual Doppler frequency shift.

FIG. 2 illustrates an example scenario 200 of Doppler frequency shift (herein interchangeably referred to as “Doppler frequency shift” and “Doppler frequency offset”) associated with an LEO satellite. In scenario 200, the LEO satellite (e.g., satellite 130) may be at a height of 600 km from the ground and may be moving relative to the ground at a speed of 7.56 kilometers per second. Accordingly, a resulting Doppler frequency shift of a signal caused by the high-speed satellite movement could be quite huge for a ground terminal (e.g., UE 110). As an example, given a carrier frequency of 2 GHz with the ground terminal being stationary, in case that the ground terminal enters satellite coverage at a 10° elevation angle, the ground terminal would experience a maximum signal frequency offset of ±46 kHz, as shown in FIG. 2.

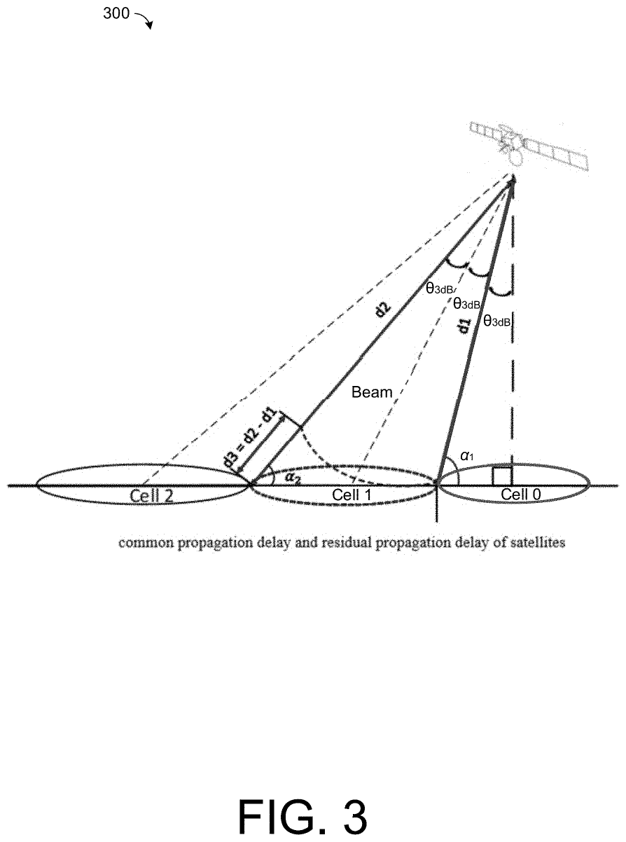

FIG. 3 illustrates an example scenario 300 of a common propagation delay and a differential propagation delay of satellite 130 as an LEO satellite orbiting at an altitude of 600 km above the ground. In general, satellite 130 may divide its coverage into a number of ground cells, each of which being formed by the irradiation of a respective beam of a plurality of antenna beams of the satellite. Satellite 130 may pre-compensate a common Doppler frequency shift for a respective beam center associated with each cell, so that the Doppler frequency shift of the received signal at the beam center would be 0 Hz.

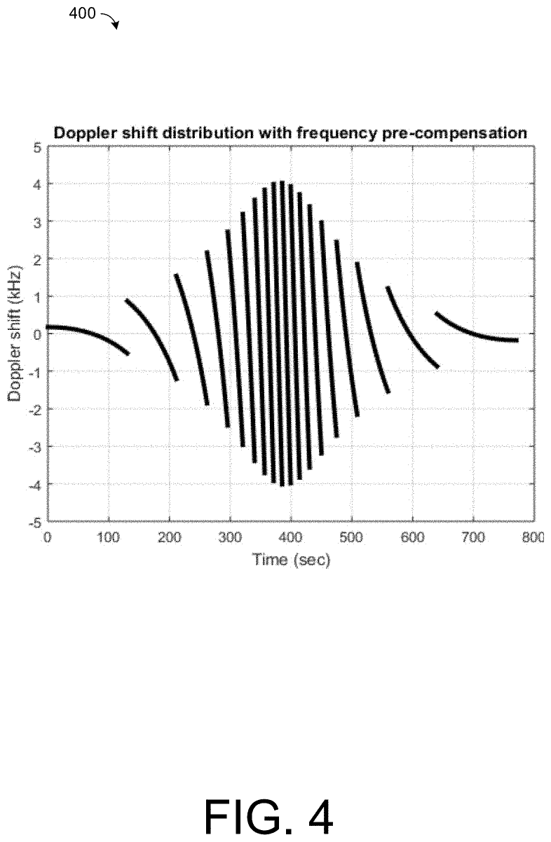

FIG. 4 illustrates an example scenario 400 of a residual Doppler frequency shift after a common pre-compensation of the Doppler frequency shift associated with an LEO satellite (e.g., satellite 130) at a height of 600 km above the ground. In scenario 400, the beam or cell radius is 50 kilometers (km) with a carrier frequency of 2 GHz. Accordingly, a ground terminal (e.g., UE 110) may experience a maximum signal frequency offset of ±4 kHz after a common Doppler shift pre-compensated by satellite 130. However, while the frequency offset pre-compensation by satellite 130 may greatly reduce the maximum signal frequency offset, UE 110 would nevertheless experience a frequency jump when changing cell (e.g., when UE 110 moves from one cell to another).On the other hand, a relatively small residual Doppler frequency offset still exist in UE 110 side and the residual Doppler frequency shift may be about ±2 parts per million (ppm).

With respect to navigation information, the navigation information may describe the location and orbital behavior of astronomic bodies such as satellites. For instance, the location information may contain satellite speed, longitude, latitude, height, and direction of motion of the satellite. Moreover, the accuracy and duration/term of validity of navigation information may depend on the details of ephemeris. The more detailed the ephemeris is, the higher accuracy and the shorter duration of validity it would be (e.g., in legacy Global Positioning Systems (GPS)). Generally, a satellite (e.g., satellite 130) may have two kinds of navigation information, namely: ephemeris and almanac. The ephemeris tends to have more detailed information, with positioning error being in terms of a few meters and the duration of validity being about a few hours. The almanac tends to have less information, with positioning error being about tends of kilometers and the duration of validity being about several months. Under various proposed schemes in accordance with the present disclosure, navigation information of NTN satellite 130 may be obtained and updated, for example, by ephemeris and/or almanac. With respect to a ground terminal, the information on location and movement may describe the location and moving behavior (e.g. speed and moving direction) of ground terminals such as UE 110. These information may be obtained through any positioning mechanisms, for example and without limitation, via a Global Navigation Satellite System (GNSS), a calculation by a positioning signaling, and/or any prior settings.

Under various proposed schemes in accordance with the present disclosure, by modifying a frequency synchronization mechanisms used in the TN system, the modified frequency synchronization mechanisms may also be used in the NTN system. In particular, the corresponding frequency synchronization mechanisms may include or otherwise involve DL frequency synchronization, UL frequency synchronization, and frequency tracking. These frequency synchronization mechanisms may be utilized for both of: (1) situations in which UE 110 has relative location information of UE 110 with respect to satellite 130, and (2) situations in which UE 110 has no relative location information of UE 110 with respect to satellite 130.

DL and UL Frequency Synchronization Mechanisms

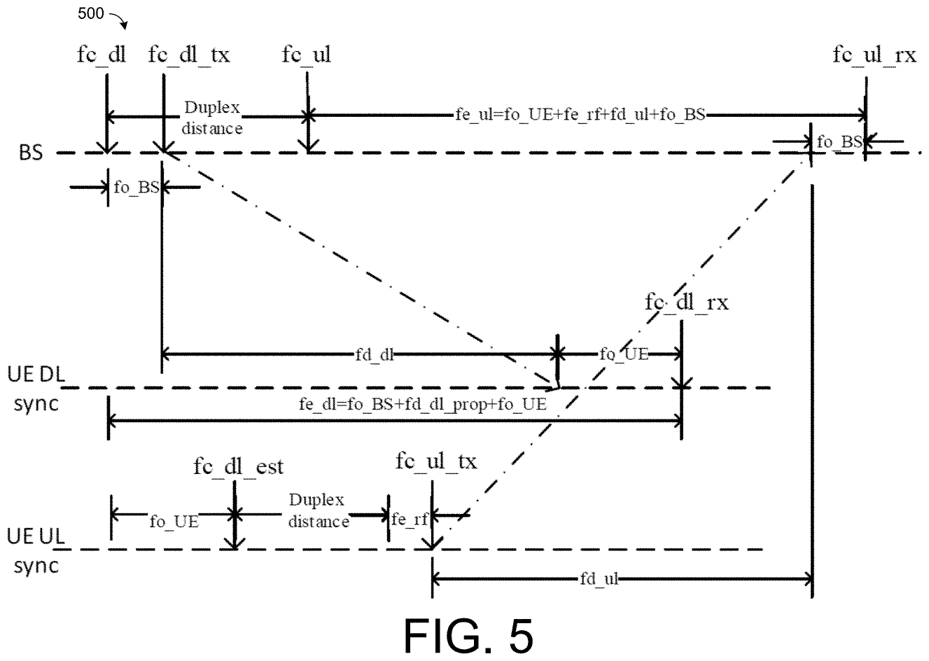

FIG. 5 illustrates an example scenario 500 of DL and UL frequency error compositions without any compensation in a mobile communication system. In scenario 500, for DL transmissions, a base station (e.g., BS 120) transmits DL signals with a downlink reference frequency (fc_dl) plus a BS crystal oscillator error (e.g., fo_BS E {±0.5 ppm} specified in 3GPP standard). A ground terminal or UE (e.g., UE 110) also has a local crystal oscillator error (e.g., fo_UE E {±10 ppm}). In legacy TN systems and GEO systems, with the BS/satellite being static, a Doppler frequency shift tends to be caused primarily by a UE movement, with the Doppler frequency shift being fd_dl E {±0.93 ppm}. When a DL signal arrives at the UE, the UE would have a total DL frequency error of (fe_dl=fo_BS+fd_dl+fo_UE) E {±11.43 ppm}. As an example, the frequency of a given carrier fc_dl=2 GHz, a maximum DL total frequency error would be +22.86 kHz. Accordingly, it would be relatively easy to perform DL synchronization since the total DL frequency error would be smaller than a frequency raster 100 kHz.

However, in NTN systems with an LEO satellite at a height of 600 km in which the satellite is asynchronous with the ground, a DL channel of NTN systems would have a large Doppler frequency shift fd_dl E {±23 ppm}. When a DL signal arrives at the UE, the UE would have a total DL frequency error (fe_dl=fo_BS+fd_dl+fo_UE) E {±33.5 ppm}. As an example, with fc_dl=2 GHz, a maximum DL total frequency error would be ±67 kHz, and the total DL frequency error(e.g.,134 kHz) would be larger than a frequency raster 100 kHz. Accordingly, the system would have a very large probability of false/wrong frequency detection for DL synchronization, thus it would be necessary to perform DL frequency shift pre-compensation before DL frequency synchronization.

For UL transmissions, an UL carrier frequency (fc_ul) would be a DL carrier frequency (fc_dl) plus a duplex distance. As such, an estimation error of DL carrier frequency would affect the UL carrier frequency, as shown in FIG. 5. In legacy TN systems and GEO systems, the Doppler frequency shift tends to be very small, and the DL frequency error tends to be caused primarily by the UE crystal oscillator error. Thus, the UE crystal oscillator error could be approximated by a total DL frequency error estimation value. However, in NTN systems with an LEO satellite asynchronous with the ground, there would be a very large Doppler frequency shift and hence it would not be easy to distinguish the Doppler frequency shift from the UE crystal oscillator error. In an event that the UE continues to use the DL frequency error estimation value (fe_dl=fo_BS+fd_dl+fo_UE) to approximate the UE crystal oscillator error, double Doppler frequency shift would be introduced to the UL total frequency error (fd_dl+fd_ul). In NTN systems with a GEO satellite synchronous with the ground, DL and UL synchronization could be similar to that for a TN system except for high-speed rail or airplane scenarios. Hence, it would be necessary to perform UL frequency shift pre-compensation.

In some implementations, the UE may determine whether to execute one or more frequency compensation procedures based on a network type (e.g., LEO/MEO/GEO/TN). That is, in case the network type is LEO or MEO, the UE may determine to perform a frequency compensation. In case the network type is GEO or TN, the UE may determine that frequency compensation is not required. In some implementations, a network node (e.g., BS) may inform the UE of information related to the network type (e.g., PLMN ID or other system information).

In some implementations, the UE may determine whether to execute one or more frequency compensation procedures based on an elevation angle of the satellite.

In some implementations, a network node (e.g., base station) may indicate to the UE information related to the elevation angle (e.g., beam ID or other system information).

In some implementations, the UE may determine to execute one or more frequency compensation procedures based on a speed of UE in an event that the UE is not stationary. For instance, when the UE is in or on an airplane or a high-speed train, the UE may determine to execute one or more frequency compensation procedures.

Otherwise, when the UE is stationary, the UE may determine not to execute one or more frequency compensation.

FIG. 6 is a diagram of an example scenario 600 of a common Doppler frequency shift pre-compensation using a frequency synchronization mechanism in accordance with the present disclosure.

Pre-Compensation of DL and/or UL Channel Doppler frequency shift by satellite/BS

Under various proposed schemes in accordance with the present disclosure, pre-compensation of a DL frequency shift and a UL frequency shift may be implemented to achieve or otherwise optimize integration of TN and NTN systems. For instance, The Doppler frequency shift in a DL channel and/or an UL channel may be pre-compensated by satellite 130 and/or BS 120. Additionally, satellite 130 and/or BS 120 may pre-compensate a common Doppler frequency shift (fd_com) before transmission of a DL signal and/or an UL signal, with a very small residual Doppler frequency offset (fd_residual) remaining on the UE side. For instance, satellite 130 and/or BS 120 may pre-compensate a common Doppler frequency shift for each beam center or cell center, so that a Doppler frequency shift of the received signal at the beam center may be 0 Hz.

As an example, with an LEO satellite at a height of 600 km, the residual Doppler frequency shift may be about ±2 ppm after pre-compensation for the common Doppler frequency shift by satellite 130 and/or BS 120(as shown in FIG. 4). Moreover, satellite 130 and/or BS 120 may dynamically pre-compensate the common Doppler frequency shift for one reference UE of a set of UEs, so that the Doppler frequency shift of a received signal at the reference UE may be 0 Hz and that the residual Doppler frequency shift of other UEs may be kept at a constant value. The reference UE may be moving relative to the satellite 130 and/or BS 120, and thus the common Doppler frequency shift may be dynamically pre-compensated by satellite 130 and/or BS 120.

Pre-Compensation of DL and/or UL Channel Doppler frequency shift by UE

Under a proposed scheme in accordance with the present disclosure, in case UE 110 has relative location information and/or relative moving information between UE 110 and satellite 130 or BS 120, UE 110 may estimate and compensate for DL and/or UL Doppler frequency shift by itself. For instance, in an event that satellite 130 or BS 120 has pre-compensated common Doppler frequency shift, UE 110 may compensate just the residual Doppler frequency shift by itself. On the other hand, in an event that satellite 130 or BS 120 has not pre-compensated common Doppler frequency shift, UE 110 may compensate the total Doppler frequency shift by itself.

### Compensation of UE Crystal Oscillator Error by UE

Under a proposed scheme in accordance with the present disclosure, UE 110 with GNSS capability may calibrate its crystal oscillator error based on a GNSS clock.

Alternatively, or additionally, UE 110 may use a good crystal oscillator (e.g. an accurate crystal oscillator of UE 110) to reduce the crystal oscillator error. Alternatively, or additionally, before connecting to the NTN network, UE 110 may calibrate its crystal oscillator through the TN network.

Due to different UE capabilities and different usage scenarios, aforementioned frequency offset compensation may be implemented in combination. Table 1 below summarizes several DL and UL frequency offset pre-compensation approaches. It is noteworthy that UL frequency offset pre-compensation may be based on DL frequency offset pre-compensation, as the estimation error of DL frequency error may affect UL carrier frequency. UL frequency offset pre-compensation may be based on DL frequency offset pre-compensation as shown in Table 1, such as case A_x of UL frequency offset pre-compensation is based on case A of DL frequency offset pre-compensation.

In general, there are different frequency error values in different NTN systems and TN systems. The specific frequency error values of cases described below are non-limiting illustrative examples of an LEO satellite (e.g., satellite 130) at a height of 600 km and a carrier frequency of 2 GHz. In these examples, the following may be assumed: the carrier frequency is fc_dl=2 GHz; the BS crystal oscillator error is fo_BS E {±0.5 ppm}; the UE crystal oscillator error is fo_UE E {±10 ppm}; e1 is a residual crystal error after correcting the crystal oscillator error; e2 is a estimation error of Doppler frequency shift by UE; the UL/DL Doppler frequency shift is fd_dl/fd_ul E {±23 ppm}; and the residual UL/DL Doppler frequency shift is fd_dl_residual/fd_ul_residual E {±2 ppm}.

TABLE 1
Frequency Error Pre-Compensation for DL/UL Frequency Synchronization

| | | | DL Doppler | | DL Doppler | |
|---|---|---|---|---|---|---|
| | | | frequency shift not | | frequency shift | |
| | | | compensated by UE | | compensated by UE | |
| | | | UE | UE | UE | UE |
| | | | crystal | crystal | crystal | crystal |
| | | | oscillator | oscillator | oscillator | oscillator |
| | | | error not | error | error not | error |
| | | | compensated | compensated | compensated | compensated |
| Frequency error compensation | | | by UE | by UE | by UE | by UE |
| Common | DL sync case | | Case 0: | Case 1: | Case 2: | Case 3: |
| Doppler | | | feasible with | feasible | feasible in | feasible in |
| frequency | | | high elevation | with high | limited | limited |
| shift not | | | angle | DL | scenarios | scenarios |
| compensated | | | | synchronization | | |
| by satellite | | | | complexity | | |
| | Need more | | YES | NO | NO | NO |
| | complicated time | | | | | |
| | offset tracking | | | | | |
| | algorithm | | | | | |
| | UL | UL Doppler | Case 0-0: | Case 1-0: | Case 2-0: | Case 3-0: |
| | sync | frequency | not feasible | not feasible | not feasible | not feasible |
| | | shift not | | | | |
| | | compensated | | | | |
| | | by UE | | | | |
| | | UL | Case 0-1: | Case 1-1: | Case 2-1: | Case 3-1: |
| | | Doppler | feasible | feasible | feasible | feasible |
| | | frequency | without | without | without | without |
| | | shift | change | change | change | change |
| | | compensated | | | | |
| | | by UE | | | | |
| Common | DL sync | | Case 4: | Case 5: | Case 6: | Case 7: |
| Doppler | | | feasible | feasible | feasible in | feasible in |
| frequency shift | | | without | without | limited | limited |
| compensated | | | change | change. | scenarios | scenarios |
| by satellite | | | | | & need | & need |
| | | | | | common | common |
| | | | | | Doppler | Doppler |
| | | | | | info | info |
| | Need more | | YES | NO | NO | NO |
| | complicated time | | | | | |
| | offset tracking | | | | | |
| | algorithm | | | | | |
| | UL | UL | Case 4-0: | Case 5-0: | Case 6-0: | Case 7-0:; |
| | sync | compensation | feasible with | feasible | feasible | feasible |
| | | case: | new PRACH | with new | with new | with new |
| | | UL Doppler | | PRACH | PRACH | PRACH |
| | | frequency | | | & need | & need |
| | | shift not | | | common | common |
| | | compensated | | | Doppler | Doppler |
| | | by UE | | | info | info |
| | | UL | Case 4-1: | Case 5-1: | Case 6-1: | Case 7-1: |
| | | compensation | cannot | feasible | feasible | feasible |
| | | case: | compensate | without | without | without |
| | | UL Doppler | OR | change | change | change |
| | | frequency | feasible | | & need | & need |
| | | shift | without | | common | common |
| | | compensated | change | | Doppler | Doppler |
| | | by UE | | | info | info |

Referring to Table 1, in Case 0, DL Doppler frequency shift may be neither compensated by satellite 130 nor by UE 110. UE crystal oscillator error may not be compensated by UE 110. In this case, the total DL frequency error on the UE side may be fe_dl=fo_BS+fd_dl+fo_UE E {±33.5 ppm} and may be larger than a frequency raster (100 kHz). The system may have a very large probability of false frequency detection for DL synchronization. This case may be limited to the systems in which fe_dl is smaller than the frequency raster, for example and without limitation, an LEO satellite system with high elevation angle beams, a GEO system, or a TN system. Accordingly, it may not be easy to distinguish the Doppler frequency shift from the UE crystal oscillator error, and UE 110 may not be able to correct the crystal oscillator error by fe_dl. The UE crystal oscillator clock may drift away because of such a large crystal oscillator error, and thus UE 110 may need more complicated time offset tracking algorithm.

Referring to Table 1, in Case 0-0, UL Doppler frequency shift may not be compensated by UE 110. Given that the UE crystal oscillator error cannot be corrected in case 0, the total UL frequency error may be fe_ul=fd_ul+fo_BS+fo_UE E {±33.5 ppm}, which is far greater than a subcarrier spacing. For example, the subcarrier spacing of a physical random access channel (PRACH) may be 1.25 kHz,7.5 kHz or15 kHz in NB-loT.

UL frequency synchronization may be unfeasible with legacy PRACH.

Referring to Table 1, in Case 0-1, UL channel Doppler frequency shift may be compensated by UE 110. That is, the UL Doppler frequency shift may approximate to the total DL frequency error (fe_dl) by UE 110. With UE 110 pre-compensating the UL Doppler frequency shift before UL transmission, the residual UL frequency error in satellite 130 may be fe_ul_residual=fe_ul - fe_dl=fd_A, where fd_A is the difference Doppler frequency shift between UL and DL. In case that the UL and DL transmissions are close enough, fd_A˜ 0. The total UL frequency error may be less than the subcarrier spacing, so UL frequency synchronization may work well with legacy PRACH in this case.

Referring to Table 1, in Case 1, DL Doppler frequency shift may be neither compensated by satellite 130 nor by UE 110. The UE crystal oscillator error may be compensated by UE 110. In this case, the residual DL frequency error in UE side may be fe_dl=fo_BS+fd_dl+el) E {±23.5 ppm+el}. In an example with fc_dl=2 GHz, the maximum residual frequency error may be about +47 kHz in DL frequency synchronization, which is close to the frequency raster (100 kHz). Thus, this case may be feasible in the situation of high DL synchronization complexity. Accordingly, In the event that the UE crystal oscillator error may be compensated by UE 110 with e1 0, UE 110 may not need more complicated time offset tracking algorithm.

Referring to Table 1, in Case 1-0, UL Doppler frequency shift may not be compensated by UE 110. With UE crystal oscillator error having been compensated by UE 110, the total UL frequency error may be fe_ul=fd_ul+e1 E {±23 ppm+el}, which is far greater than the subcarrier spacing. Thus, UL frequency synchronization may be unfeasible with legacy PRACH.

Referring to Table 1, in Case 1-1, the UL channel Doppler frequency shift may be compensated by UE 110. That is, the UL Doppler frequency shift may approximate to the total DL frequency error (fe_dl) by UE 110. With UE pre-compensating the UL Doppler frequency shift before UL transmission, the residual UL frequency error may be fe_ul_residual=fe_ul - fe_dl=fd_A, and fd_A may be the same as that in case 0-1. The residual UL frequency error may be far less than the subcarrier spacing, and thus UL frequency synchronization may work well with legacy PRACH in this case.

Referring to Table 1, in Case 2, DL Doppler frequency shift may be compensated by UE 110, and UE crystal oscillator error may not be compensated by UE 110. In this case, the residual DL frequency error in UE side may be fe_dl=fo_BS+fo_UE+e2) E {±10.5 ppm+e2}. The maximum residual frequency error may be far less than frequency raster, so that the DL frequency synchronization may work well without any change in this case.

It is noteworthy that this case may be feasible in scenarios in which UE 110 has the relative location information and moving information of UE 110 and satellite 130.

However, before DL initial frequency synchronization, it is possible that UE 110 may not have acquired the effective ephemeris (e.g., during initial power-on or when pre-stored navigation information is out of date), and thus UE 110 may not have the relative location information and moving information of UE 110 and satellite 130. In such scenarios, UE 110 would not be able to estimate the DL Doppler frequency shift by itself. Accordingly, in case that DL Doppler frequency shift has been compensated by UE 110, the residual DL frequency error (fe_dl) may be approximated as the UE crystal oscillator error, and the residual crystal oscillator error may be el=fo_UE - fe_dl=-fo_BS - e2. Thus, there is no need for more complicated time offset tracking algorithm.

Referring to Table 1, in Case 2-0, UL Doppler frequency shift may not be compensated by UE 110. Given that the residual DL frequency error (fe_dl) has been approximated as UE crystal oscillator error, the total UL frequency error may be fe_ul=fd_ul+fo_BS+e1=fd_ul - e2=±23 ppm - e2, which is far greater than the subcarrier spacing. Accordingly, the UL frequency synchronization may be unfeasible with legacy PRACH.

Referring to Table 1, in Case 2-1, UL channel Doppler frequency shift may be compensated by UE 110. In this case, with the capability to estimate UL and DL Doppler frequency shifts, UE 110 may estimate fd_ul directly or, alternatively, UE 110 may approximate fd_dl as fd_ul and then pre-compensate fd_ul before UL transmission. The residual UL frequency error may be fe_ul_residual=fe_ul - fd_ul - e2=−2 * e2, and the residual UL frequency error may be far less than the subcarrier spacing. Accordingly, the UL frequency synchronization may work well with legacy PRACH in this case.

Referring to Table 1, in Case 3, the DL Doppler frequency shift may be compensated by UE 110, and the UE crystal oscillator error may be also compensated by UE 110. In this case, the residual DL frequency error in UE side may be fe_dl=fo_BS+e1+e2=iO.5 ppm+e1+e2. The system performance and usage scenarios of Case 3 may be similar with Case 2 but with smaller value of residual DL frequency error.

Referring to Table 1, in Case 3-0, UL Doppler frequency shift may not be compensated by UE 110. Additionally, Case 3-0 may be the same as Case 1-0 in which UL frequency synchronization may be unfeasible with legacy PRACH. Moreover, in Case 3-1, the UL channel Doppler frequency shift may be compensated by UE 110.

Furthermore, Case 3-1 may be the same as Case 2-1 in which UL frequency synchronization may work well with legacy PRACH except that the values of e1 for two cases are different.

Referring to Table 1, in Case 4, a common Doppler frequency shift may be compensated by satellite 130, and a UE crystal oscillator error may not be compensated by UE 110. In this case, the residual DL frequency error in UE side may be fe_dl=fd_dl_residual+fo_BS+fo_UE=±12.5 ppm. The maximum residual frequency error may be far less than the frequency raster, so DL frequency synchronization may work well without any change in this case. Because of a large residual Doppler frequency shift, it may not be easy to distinguish the Doppler frequency shift with the UE crystal oscillator error. In case that UE 110 does not correct the UE crystal oscillator error by fe_dl, e1=fo_UE, the crystal clock of UE may drift away because of a large crystal oscillator error. Accordingly, UE 110 may need a more complicated time offset tracking algorithm. In case that UE 110 corrects the crystal error by fe_dl, e1=-fd_dl_residual- fo_BS, UE 110 may need a more complicated time offset tracking algorithm in a high elevation angle.

Referring to Table 1, in Case 4-0, UL Doppler frequency shift may not be compensated by UE 110. In case that the UE crystal oscillator error has not been corrected, the total UL frequency error may be feui=fdulᵣₑₛidᵤₐi+foBS+foUE ±12.5 ppm, which is far larger than the subcarrier spacing. Accordingly, UL frequency synchronization may be unfeasible with legacy PRACH. In case that the UE oscillator crystal error has been corrected with fe_dl, the total UL frequency error may be fe_ul=fd_ul_residual+2 * fo_BS+fd_dl_residual=±5 ppm, which is little larger than the subcarrier spacing. Accordingly, UE 110 may need a more effective PRACH against frequency error, such as the PRACH with a M sequence, a Gold sequence or a dual ZC sequence. Alternatively, UE 110 may reserve a protection interval in PRACH frequency domain to resist such a large frequency offset error.

Referring to Table 1, in Case 4-1, UL channel Doppler frequency shift may be compensated by UE 110. In case that the UE crystal oscillator error has not been corrected, the total DL frequency error (fe_dl) may be approximated as the UL Doppler frequency shift. Then, UE 110 may pre-compensate the fe_dl before UL transmission, and the residual UL frequency error may be fe_ul_residual=fe_ul - fe_dl=fd_A, with fd_A being the same as that in case 0-1. The residual UL frequency error may be far less than the subcarrier spacing. Accordingly, UL frequency synchronization may work well with legacy PRACH in this case. In case that the UE crystal oscillator error has been corrected with fe_dl, UE 110 may not pre-compensate the UL channel Doppler frequency shift.

Referring to Table 1, in Case 5, a common Doppler frequency shift may be compensated by satellite 130, and the UE crystal oscillator error may be compensated by UE 110. This case may be similar with case 1, except that the common Doppler frequency shift has been compensated by satellite 130. The residual DL frequency error in UE side may be fe_dl=fd_dl_residual+fo_BS+e1=±2.5 ppm+el. DL frequency synchronization may work well without any change in this case. Moreover, the UE crystal oscillator error may be compensated by UE 110 based on a GNSS or other methods, resulting in e1 0. Accordingly, UE 110 may not need a more complicated time offset tracking algorithm.

Referring to Table 1, in Case 5-0, UL Doppler frequency shift may not be compensated by UE 110. Given that the UE crystal oscillator error has been compensated by UE 110, the total UL frequency error may be fe_ul=fd_ul_residual+fo_BS+e1=±2.5 ppm+e1, which is little greater than the subcarrier spacing. Accordingly, UE 110 may need a more effective PRACH against the frequency error, such as the PRACH with a M sequence, a Gold sequence or a dual ZC sequence. Alternatively, UE 110 may reserve a protection interval in PRACH frequency domain to resist such a large frequency offset error.

Referring to Table 1, in Case 5-1, UL channel Doppler frequency shift may be compensated by UE 110. The residual DL frequency error (fe_dl) may be approximated as UL Doppler frequency shift, and thus the residual UL frequency error may be fe_ul_residual=fe_ul - fe_dl=fd_A, with fd_A being the same as that in case 0-1. The residual UL frequency error may be far less than the subcarrier spacing. Accordingly, UL frequency synchronization may work well with legacy PRACH in this case.

Referring to Table 1, in Case 6, the DL Doppler frequency shift may be compensated both by UE 110 and by satellite 130/BS 120, and the UE crystal oscillator error may not be compensated by UE 110. This case may be the same as Case 2, and it may be feasible in scenarios in which UE 110 has the relative location information and moving information of UE 110 and satellite 130, e1=fo_UE - fe_dl=-fo_BS - e2. In addition, the system may inform UE 110 of the common Doppler frequency shift value which may be pre-compensated by satellite 130 (e.g., broadcasted in the system information by BS 120/satellite 130). Alternatively, or additionally, UE 110 may obtain the common delay values in advance, for example, though ephemeris or almanac.

Referring to Table 1, in Case 6-0, UL Doppler frequency shift may not be compensated by UE 110. Given that the residual DL frequency error (fe_dl) has been approximated as the UE crystal oscillator error, the total UL frequency error may be fe_ul=fd_ul_residual+fo_BS+e1=fd_ul_residual - e2=±2 ppm - e2, which is little greater than the subcarrier spacing. Accordingly, UE 110 may need a more effective PRACH against the frequency error, such as the PRACH with a M sequence, a Gold sequence or a dual ZC sequence. Alternatively, UE 110 may reserve a protection interval in PRACH frequency domain to resist such a large frequency offset error. In addition, the system may inform UE 110 of the common Doppler frequency shift value which may be pre-compensated by satellite 130.

Referring to Table 1, in Case 6-1, UL channel Doppler frequency shift may be compensated by UE 110. In this case, with the capability to estimate the UL and DL Doppler frequency shift, UE 110 may estimate fd_ul directly or approximate fd_dl as fd_ul, then UE 110 may pre-compensate fd_ul before UL transmission. The residual UL frequency error may be fe_ul_residual=fe_ul-fd_ul_residual-e2=2*e2=−2*e2, and the residual UL frequency error may be far less than the subcarrier spacing. Accordingly, UL frequency synchronization may work well with legacy PRACH in this case. In addition, the system may inform UE 110 the common Doppler frequency shift value which may be pre-compensated by satellite 130.

Referring to Table 1, in Case 7, DL Doppler frequency shift may be compensated both by UE 110 and satellite 130/BS 120, and the UE crystal oscillator error may also be compensated by UE 110. In this case, the residual DL frequency error in UE side may be about fe_dl=fo_BS+e1+e2=±O.5 ppm+e1+e2. The system performance and usage scenarios of Case 7 may be similar with that of Case 6 but with a smaller value of residual DL frequency error. In addition, the system may inform UE 110 the common Doppler frequency shift value which may be pre-compensated by satellite 130.

Referring to Table 1, in Case 7-0, UL Doppler frequency shift may not be compensated by UE 110, and Case 7-0 may be the same as Case 5-0. In addition, the system may inform UE 110 the common Doppler frequency shift value which may be pre-compensated by satellite 130. Moreover, in Case 7-1, UL channel Doppler frequency shift may be compensated by UE 110. Furthermore, Case 7-1 may be the same as Case 6-1 in which UL frequency synchronization may work well with legacy PRACH except that the values of e1 for two cases are different. In addition, the system may inform UE 110 the common Doppler frequency shift value which may be pre-compensated by satellite 130.

In summary, in a network system with a large Doppler frequency shift such as an LEO/MEO system, for DL frequency synchronization, Case 0 may be utilized in cases of a high-elevation angle; Case 1 may be utilized in cases of a high DL synchronization complexity without elevation limit; Cases 2/3/6/7 may require UE 110 to have the effective relative location information and moving information of UE 110 and satellite 130; Cases 0/4 may require a more complicated time offset tracking algorithm; and Case 5 may work well without any restriction. For UL frequency synchronization, Cases 0-0/1-0/2-0/3-0 may be unfeasible because of a rather large UL frequency error; Cases 4-0/5-0/6-0/7-0 may be feasible with a new PRACH design; Cases 2-1/3-1/6-1/7-1 may require UE 110 to have the effective relative location information and moving information of UE 110 and satellite 130, in addition to information of the common Doppler frequency shift value provided by the system to UE 110 in cases 6-1 and 7-1; Cases 0-1/4-1 may require a more complicated time offset tracking algorithm; and Cases 1-1/5-1 may work well without any restriction.

For a network with a small Doppler frequency shift such as a TN system or a GEO system without high-speed rail or airplane scenarios, the aforementioned cases may all be feasible without any change to a legacy mobile communication system. Additionally, UE 110 may dynamically combine the cases above according to its own capabilities, network types and usage scenarios. For instance, given that there are no navigation information in DL initial frequency synchronization, Case 1 may be utilized for DL initial Attorney Docket No.: MDTK.0522US frequency synchronization and, after obtaining navigation information via system information block (SIB), Case 6-1 may be utilized for UL frequency synchronization.

### Frequency Tracking

Under a proposed scheme in accordance with the present disclosure with respect to frequency tracking, various proposed schemes are described below in the context of specific frequency error values in case of an LEO satellite (e.g., satellite 130) at a height of 600 km with a carrier frequency of 2 GHz, although the proposed schemes may be applicable in other scenarios.

It is noteworthy that, Doppler frequency shift may be time-varying (e.g., at a Doppler frequency shift drift rate of 544 Hz/s) and assuming a crystal oscillator error may also change with a temperature drift. Thus, under the proposed scheme, as the frequency error of the communication system may always drift away after DL frequency synchronization, UE 110 and/or BS 120 may perform real-time tracking of the drift in frequency offset.

If case that UE/BS reception is continuous, simulation result shows a Doppler frequency shift drift rate of 544 Hz/s is not a problem for a legacy Auto Frequency Compensation (AFC) algorithm. However, in an event that the UE/BS reception is interrupted for a long time (e.g., due to system information (SI) or paging reception, discontinuous reception (DRX), transmission/reception (TX/RX) switch in half duplex-frequency division duplex (HD-FDD) and so on), Doppler frequency shift may drift a lot by the rate of 544 Hz/s, then the AFC algorithm would not work well anymore. Thus, several cases and methods of frequency tracking with discontinuous reception under the proposed scheme are summarized below in Table 2.

TABLE 2
Frequency Error Pre-Compensation for Frequency Tracking

| | Discontinuous reception | |
|---|---|---|
| frequency | sufficient time | Insufficient time |
| tracking case | for re-sync | for re-sync |
| without | Case 0-0: | Case 1-0: |
| position | do DL frequency re- | Method1: AFC algorithm |
| information | synchronization | with Kalman filter; |
| | by search | Method2: UE/BS compensate |
| | PSS/SSS | Doppler frequency shift |
| | | by RX sleep time multiply |
| | | Doppler offset drift rate; |
| | | Method3: BS/UE Reserve |
| | | enough gap for DL frequency |
| | | synchronization |
| | | within TX/RX transmission |
| with | Case 0-1: | Case 1-1: |
| position | Method1: UE estimate | same as |
| information | Doppler frequency | case0-1 |
| | offset by position | |
| | information; | |
| | Method2: UE can estimate | |
| | Doppler offset drift | |
| | rate by position | |
| | information; | |

Referring to Table 2, in Case 0, after UE reception is interrupted there may be sufficient time to perform downlink re-synchronization. In Case 0-0, UE 110 cannot have relative location information and moving information of UE 110 and satellite 130.

Accordingly, UE 110 may have sufficient time to search a primary synchronization signal (PSS) and/or a secondary synchronization signal (SSS) again for DL re-synchronization after reception (RX) sleep (e.g., SI/paging reception and DRX). UE 110 may perform DL frequency re-synchronization by the methods of DL frequency synchronization described above. In Case 0-1, UE 110 may have relative location information and moving information of UE 110 and satellite 130. Accordingly, UE 110 may estimate its Doppler frequency offset or Doppler offset drift rate by relative motion of satellite 130 corresponding to UE 110. In case that UE 110 estimates Doppler offset drift rate by relative location information and moving information of UE 110 and satellite 130, UE 110 may compensate Doppler frequency shift by an amount equal to a duration of its RX sleep time multiplied by the Doppler offset drift rate.

Referring to Table 2, in Case 1, after UE/BS reception is interrupted, there may be no insufficient time to perform re-synchronization. In Case 1-0, UE 110 cannot have relative location information and moving information of UE 110 and satellite 130.

Accordingly, UE 110 may have insufficient time to search a PSS/SSS again for DL re-synchronization after RX sleep (e.g., RX/TX switch in HD-FDD). Under the proposed scheme, several methods of frequency tracking may be utilized under these circumstances.

In a Method 1, UE 110 and/or BS 120 may use the AFC algorithm with a Kalman filter to predict the Doppler frequency shift drift rate to track frequency error. In a Method 2, UE 110 and/or BS 120 may compensate Doppler frequency shift by an amount equal to a duration of its RX sleep time multiplied by the Doppler offset drift rate. Moreover, BS 120 may inform the Doppler frequency shift drift rate to UE 110, e.g., by directly broadcasting or indirectly via system information or other messages. In a Method 3, UE 110 and/or BS 120 may reserve a gap with a duration sufficient for (that is, greater than a time for) UL and/or DL frequency synchronization within RX/TX transmission. For instance, UE 110 and/or BS 120 may reserve a 80-ms gap for DL synchronization after a 256-ms transmission.

Referring to Table 2, in Case 1-1, UE 110 may have relative location information and moving information of UE 110 and satellite 130. Accordingly, as in Case 0-1, UE 110 may estimate its Doppler frequency offset or Doppler offset drift rate by relative motion of satellite 130 corresponding to UE 110, so that UE 110 may compensate Doppler frequency shift by an amount equal to a duration of its RX sleep time multiplied by the Doppler offset drift rate.

In one novel aspect of the present disclosure, UE 110 may dynamically whether to perform frequency compensation by at least one of DL frequency synchronization, UL frequency synchronization, and frequency tracking determine, according to a magnitude of Doppler frequency shift in a network system.

Acquisition and Updating of Navigation Information

Generally, a satellite (e.g., satellite 130) may have two kinds of navigation information, namely: ephemeris and almanac. Under a proposed scheme in accordance with the present disclosure, whether to use ephemeris or almanac may be dependent on the requirements of positioning error.

Under the proposed scheme, in case that Doppler frequency offset is estimated by positioning information for DL frequency synchronization, with an error tolerance of frequency error being+50 kHz and an error tolerance of positioning information being about thousands of kilometers, then UE 110 may need to update positioning information once (and not more times) in a given beam for Doppler offset drift rate estimation.

Under the proposed scheme, in case that Doppler frequency offset is estimated by positioning information for UL frequency synchronization, with an error tolerance of frequency error being+7.5 kHz and an error tolerance of positioning information being about dozens of kilometers, then UE 110 may need to update positioning information once (and not more times) in a given beam for Doppler offset drift rate estimation.

In case that Doppler offset drift rate is estimated by positioning information for frequency tracking, the Doppler offset drift rate may change slowly with time and may even be considered as a constant within a satellite beam with the radius of dozens of kilometers. Therefore, the error tolerance of positioning information may be about dozens of kilometers and, under the proposed scheme, UE 110 may need to update positioning information once (and not more times) in a given beam for Doppler offset drift rate estimation.

In case that Doppler frequency offset is estimated by positioning information for frequency tracking, assuming the tolerable error of AFC is ±50 Hz, the maximum Doppler offset drift rate is 544 Hz/s and the speed of the satellite is 7.56 km/s, then the error tolerance of positioning information may be about ±50(Hz)/544(Hz/s)*7.56 ( )˜+682(m). Meanwhile, UE 110 may update positioning information more frequently for Doppler offset drift rate estimation. With NB-loT as an example, there may be a 40-ms gap for DL synchronization after a 256-ms transmission, and thus UE 110 may need to update GNSS every 256 ms.

Therefore, in case there is no need for estimation of Doppler frequency shift directly for frequency tracking, the almanac may be used for NTN system as satellite navigation information. Otherwise, the ephemeris may be used for NTN system as navigation information.

It is noteworthy that navigation information of different satellite systems may have different accuracies, durations of validity and date sizes. Accordingly, under a proposed scheme in accordance with the present disclosure, methods of acquisition and updating of navigation information (e.g., almanac or ephemeris) for various satellite systems may be utilized.

As mentioned above, the navigation information has a limited duration of validity and thus would need to be updated in time. For instance, satellite 130 may provide navigation information by system information. Alternatively, or additionally, UE 110 may obtain navigation information through ground network (TN system) via BS 120.

A special system message SIBx is proposed to transmit the navigation information, which has a special duration of validity and a special updated method and the transmission period of SIBx may be dynamically adjusted according to the duration of validity of navigation information of different satellite systems. Under the proposed scheme, BS 120 may also decide whether to schedule the special SIBx according to NTN or TN. In one example, the type of mobile communication networks may be broadcasted in system information by a PLMN identity.

Under the proposed scheme, the navigation information may be divided into long-term effective information and real-time change information. The long-term effective information (e.g., orbit information), also referred to as initial navigation information, may be directly stored in UE 110 or transmitted to UE 110 via system information. The real-time change information (e.g., special satellite information), also referred to as dynamic navigation information, may be transmitted to UE 110 dynamically.

Under the proposed scheme, the navigation information may have a long time of effectiveness (e.g., several hours to several months) and a large amount of data. Once UE 110 receives the navigation information, UE 110 may not need to receive the navigation information again within its validity period. In one example, the navigation information may be stored before power-down, and UE 110 may directly use the stored effective navigation information after power-on again.

According to different use scenarios, satellite 130 may choose to broadcast only its own ephemeris, or broadcast ephemeris of multiple satellites at the same time (e.g., those satellites near satellite 130), or broadcast ephemeris in the whole orbit(e.g., all satellites on the orbit). Under the proposed scheme, for an LEO system, UE 110 may frequently switch between different satellites, so that the navigation information of all satellites in one orbit may be broadcasted to avoid the need for UE 110 obtaining navigation information frequently (which would result in high power consumption). Then, once UE 110 receives and stores the navigation information, UE 110 would not need to receive the navigation information again within its validity period, and UE 110 may select suitable navigation information by satellite identification (ID).

### Illustrative Implementations

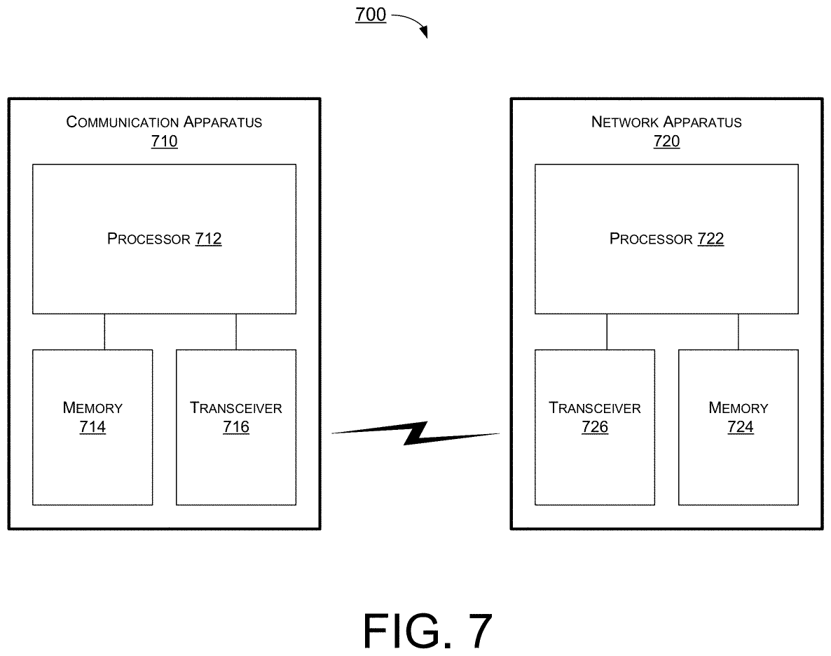

FIG. 7 illustrates an example communication system 700 having an example apparatus 710 and an example apparatus 720 in accordance with an implementation of the present disclosure. Each of apparatus 710 and apparatus 720 may perform various functions to implement schemes, techniques, processes and methods described herein pertaining to timing handling for integration of TN and NTN communications, including various schemes described above as well as process 700 described below.

Each of apparatus 710 and apparatus 720 may be a part of an electronic apparatus, which may be a UE such as a portable or mobile apparatus, a wearable apparatus, a wireless communication apparatus or a computing apparatus. For instance, each of apparatus 710 and apparatus 720 may be implemented in a smartphone, a smartwatch, a personal digital assistant, a digital camera, or a computing equipment such as a tablet computer, a laptop computer or a notebook computer. Each of apparatus 710 and apparatus 720 may also be a part of a machine type apparatus, which may be an IoT or NB-loT apparatus such as an immobile or a stationary apparatus, a home apparatus, a wire communication apparatus or a computing apparatus. For instance, each of apparatus 710 and apparatus 720 may be implemented in a smart thermostat, a smart fridge, a smart door lock, a wireless speaker or a home control center. Alternatively, each of apparatus 710 and apparatus 720 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. Each of apparatus 710 and apparatus 720 may include at least some of those components shown in FIG. 7 such as a processor 712 and a processor 722, respectively. Each of apparatus 710 and apparatus 720 may further include one or more other components not pertinent to the proposed scheme of the present disclosure (e.g., internal power supply, display device and/or user interface device), and, thus, such component(s) of each of apparatus 710 and apparatus 720 are neither shown in FIG. 7 nor described below in the interest of simplicity and brevity.

In some implementations, at least one of apparatus 710 and apparatus 720 may be a part of an electronic apparatus, which may be a network node, a satellite or base station (e.g., eNB, gNB or TRP), a small cell, a router or a gateway. For instance, at least one of apparatus 710 and apparatus 720 may be implemented in an eNodeB in an LTE, LTE-Advanced or LTE-Advanced Pro network or in a gNB in a 5G, NR, IoT or NB-loT network. Alternatively, at least one of apparatus 710 and apparatus 720 may be implemented in the form of one or more IC chips such as, for example and without limitation, one or more single-core processors, one or more multi-core processors, or one or more CISC or RISC processors.

In one aspect, each of processor 712 and processor 722 may be implemented in the form of one or more single-core processors, one or more multi-core processors, or one or more CISC or RISC processors. That is, even though a singular term “a processor” is used herein to refer to processor 712 and processor 722, each of processor 712 and processor 722 may include multiple processors in some implementations and a single processor in other implementations in accordance with the present disclosure. In another aspect, each of processor 712 and processor 722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 712 and processor 722 is a special-purpose machine specifically designed, arranged and configured to perform specific tasks including timing handling for integration of TN and NTN communications in accordance with various implementations of the present disclosure.

In some implementations, apparatus 710 may also include a transceiver 716 coupled to processor 712 and capable of wirelessly transmitting and receiving data.ln some implementations, apparatus 710 may further include a memory 714 coupled to processor 712 and capable of being accessed by processor 712 and storing data therein.

In some implementations, apparatus 720 may also include a transceiver 726 coupled to processor 722 and capable of wirelessly transmitting and receiving data. In some implementations, apparatus 720 may further include a memory 724 coupled to processor 722 and capable of being accessed by processor 722 and storing data therein. Accordingly, apparatus 710 and apparatus 720 may wirelessly communicate with each other via transceiver 716 and transceiver 726, respectively.

To aid better understanding, the following description of the operations, functionalities and capabilities of each of apparatus 710 and apparatus 720 is provided in the context of communication environment 100 in which apparatus 710 is implemented in or as a wireless communication device, a communication apparatus or a UE (e.g., UE 110) and apparatus 720 is implemented in or as a network node (e.g., BS 120 or satellite 130).

In one aspect of frequency synchronization for integration of TN and NTN communications in accordance with the present disclosure, processor 712 of apparatus 710, as UE 110, may establish communications with a BS of a TN. Moreover, processor 712 may establish communications with an NT network node of an NTN. Additionally, processor 712 may compensate for a frequency shift in the communications between apparatus 710 and the NTN regardless of availability of information related to a movement of apparatus 710 and a relative location of the NT network node of the NTN with respect to apparatus 710.

In some implementations, processor 712 may further compensate for the frequency shift based on at least one of the following: (1) performing DL or UL frequency synchronization; and (2) performing a frequency tracking.

In some implementations, processor 712 may further compensate a UL Doppler frequency shift by approximating the UL Doppler frequency shift based on a total DL frequency error.

In some implementations, processor 712 may further perform certain operations. For instance, processor 712 may obtain navigation information of the NT network node. Additionally, processor 712 may compensate for the frequency shift based on the navigation information of the NT network node.

In some implementations, in obtaining the navigation information, processor 712 may perform at least one of the following: (a) obtaining the navigation information using an ephemeris or almanac; (b) receiving, from apparatus 720 (as the BS or the NT network node), system information containing the navigation information; or (c) retrieving the navigation information from a memory device.

In some implementations, processor 712 may also receive, via transceiver 716, system information from apparatus 720 (as the BS) indicating that a common Doppler frequency shift is pre-compensated by the BS or the NT network node. In such cases, the common Doppler frequency shift may include a DL common Doppler frequency shift and a UL common Doppler frequency shift.

In some implementations, in compensating for the frequency shift, processor 712 may compensate for a crystal oscillator error by calibrating a crystal oscillator through the TN network or based on a GNSS clock.

In some implementations, processor 712 may further perform DL frequency re-synchronization by searching either or both of a PSS and an SSS.

In some implementations, processor 712 may further track a frequency error by using an AFC algorithm with a Kalman filter to predict a drift rate of a Doppler frequency shift.

In some implementations, processor 712 may further compensate for a Doppler frequency shift based one a duration of a RX sleep time and a drift rate of the Doppler frequency shift, and wherein the drift rate of the Doppler frequency shift is broadcasted by the BS in system information.

In some implementations, processor 712 may further reserve a gap with a duration sufficient for frequency synchronization within a TX/RX.

In some implementations, processor 712 may further estimate a Doppler frequency offset or a drift rate of a Doppler frequency shift based on relative location information and moving information of apparatus 710 and the NT network node.

In some implementations, in compensating for the frequency shift, processor 712 may obtain relative location information of apparatus 710 and the NT network node.

In some implementations, in obtaining the relative location information of apparatus 710 and the NT network node, processor 712 may perform at least one of the following: (a) positioning apparatus 710 based on a GNSS, a positioning signaling, or a priori setting; and (b) positioning the NT network node based on an ephemeris or almanac or based on information stored in a memory device (e.g., memory 714).

In some implementations, in compensating for the frequency shift, processor 712 may obtain at least one of the following: information indicating a network type, an elevation angle of the NT network node, a drift rate of a Doppler frequency shift, a common Doppler frequency shift, and an ephemeris.

### Illustrative Processes

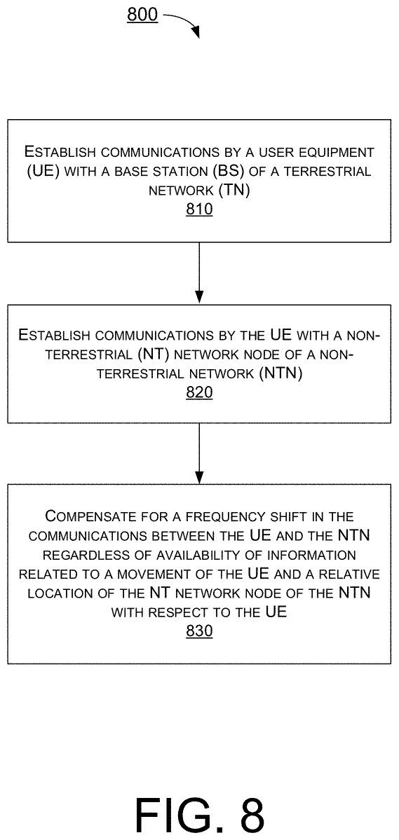

FIG. 8 illustrates an example process 800 in accordance with an implementation of the present disclosure. Process 800 may be an example implementation of the proposed schemes described above with respect to timing handling for integration of TN and NTN communications in accordance with the present disclosure. Process 800 may represent an aspect of implementation of features of apparatus 710 and apparatus 720.

Process 800 may include one or more operations, actions, or functions as illustrated by one or more of blocks 810, 820 and 830. Although illustrated as discrete blocks, various blocks of process 800 may be divided into additional blocks, combined into fewer blocks, or eliminated, depending on the desired implementation. Moreover, the blocks of process 800 may executed in the order shown in FIG. 8 or, alternatively, in a different order.

Process 800 may also be repeated partially or entirely. Process 800 may be implemented by apparatus 710, apparatus 720 and/or any suitable wireless communication device, UE, base station or machine type devices. Solely for illustrative purposes and without limitation, process 800 is described below in the context of apparatus 710 as a UE (e.g., UE 110) and apparatus 720 as a network node (e.g., base station 120 or satellite 130). Process 800 may begin at block 810.

At 810, process 800 may involve processor 712 of apparatus 710, as UE 110, establishing communications with a BS of a TN. Process 800 may proceed from 810 to 820.

At 820, process 800 may involve processor 712 establishing communications with an NT network node of an NTN. Process 800 may proceed from 820 to 830.

At 830, process 800 may involve processor 712 compensating for a frequency shift in the communications between apparatus 710 and the NTN regardless of availability of information related to a movement of apparatus 710 and a relative location of the NT network node of the NTN with respect to apparatus 710.

In some implementations, process 800 may further involve processor 712 compensating for the frequency shift based on at least one of: (1) performing DL or UL frequency synchronization; and (2) performing a frequency tracking.

In some implementations, process 800 may further involve processor 712 compensating a UL Doppler frequency shift by approximating the UL Doppler frequency shift based on a total DL frequency error.

In some implementations, process 800 may further involve processor 712 performing certain operations. For instance, process 800 may involve processor 712 obtaining navigation information of the NT network node. Additionally, process 800 may involve processor 712 compensating for the frequency shift based on the navigation information of the NT network node.

In some implementations, in obtaining the navigation information, process 800 may involve processor 712 performing at least one of the following: (a) obtaining the navigation information using an ephemeris or almanac; (b) receiving, from apparatus 720 (as the BS or the NT network node), system information containing the navigation information; or (c) retrieving the navigation information from a memory device.

In some implementations, process 800 may further involve processor 712 receiving, via transceiver 716, system information from apparatus 720 (as the BS) indicating that a common Doppler frequency shift is pre-compensated by the BS or the NT network node. In such cases, the common Doppler frequency shift may include a DL common Doppler frequency shift and a UL common Doppler frequency shift.

In some implementations, in compensating for the frequency shift, process 800 may involve processor 712 compensating for a crystal oscillator error by calibrating a crystal oscillator through the TN network or based on a GNSS clock.

In some implementations, process 800 may further involve processor 712 performing DL frequency re-synchronization by searching either or both of a PSS and an SSS.

In some implementations, process 800 may further involve processor 712 tracking a frequency error by using an AFC algorithm with a Kalman filter to predict a drift rate of a Doppler frequency shift.

In some implementations, process 800 may further involve processor 712 compensating for a Doppler frequency shift based on a duration of a RX sleep time and a drift rate of the Doppler frequency shift, and wherein the drift rate of the Doppler frequency shift is broadcasted by the BS in system information.

In some implementations, process 800 may further involve processor 712 reserving a gap with a duration sufficient for frequency synchronization within a TX/RX.

In some implementations, process 800 may further involve processor 712 estimating a Doppler frequency offset or a Doppler frequency shift drift rate based on relative location information and moving information of apparatus 710 and the NT network node.

In some implementations, in compensating for the frequency shift, process 800 may involve processor 712 obtaining relative location information of apparatus 710 and the NT network node.

In some implementations, in obtaining the relative location information of apparatus 710 and the NT network node, process 800 may involve processor 712 performing at least one of: (a) positioning apparatus 710 based on a GNSS, a positioning signaling, or a priori setting; and (b) positioning the NT network node based on an ephemeris or almanac or based on information stored in a memory device (e.g., memory 714).

In some implementations, in compensating for the frequency shift, process 800 may involve processor 712 obtaining at least one of the following: information indicating a network type, an elevation angle of the NT network node, a drift rate of a Doppler frequency shift, a common Doppler frequency shift, and an ephemeris.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc.

It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. A method, comprising:
establishing communications by a user equipment (UE) with a base station (BS) of a terrestrial network (TN);
establishing communications by the UE with a non-terrestrial (NT) network node of a non-terrestrial network (NTN); and
compensating for a frequency shift in the communications between the UE and the NTN regardless of availability of information related to a movement of the UE and a relative location of the NT network node with respect to the UE.

2. The method of claim 1, further comprising: compensating for the frequency shift based on at least one of:
performing downlink (DL) or uplink (UL) frequency synchronization; and
performing a frequency tracking.

3. The method of claim 2, further comprising compensating, by the UE, a UL Doppler frequency shift by approximating the UL Doppler frequency shift based on a total DL frequency error.

4. The method of claim 2, further comprising:
obtaining, by the UE, navigation information of the NT network node; and
compensating, by the UE, for the frequency shift based on the navigation information of the NT network node.

5. The method of claim 4, wherein the obtaining of the navigation information comprises performing at least one of:
obtaining the navigation information using an ephemeris or almanac;
receiving, from the BS or the NT network node, system information containing the navigation information; and
retrieving the navigation information from a memory device.

6. The method of claim 2, further comprising:
receiving, by the UE, system information from the BS indicating that a common Doppler frequency shift is pre-compensated by the BS or the NT network node,
wherein the common Doppler frequency shift includes a DL common Doppler frequency shift and a UL common Doppler frequency shift.

7. The method of claim 2, wherein further comprising performing, by the UE, DL frequency re-synchronization by searching either or both of a primary synchronization signal (PSS) and a secondary synchronization signal (SSS).

8. The method of claim 2, further comprising tracking, by the UE, a frequency error by using an auto-frequency compensation (AFC) algorithm with a Kalman filter to predict a drift rate of a Doppler frequency shift.

9. The method of claim 2, further comprising compensating, by the UE, for a Doppler frequency shift based on a duration of a receiver (RX) sleep time and a drift rate of the Doppler frequency shift, and wherein the drift rate of the Doppler frequency shift is broadcasted by the BS in system information.

10. The method of claim 2, further comprising reserving, by the UE, a gap with a duration sufficient for frequency synchronization within a transmission or reception (TX/RX).

11. The method of claim 2, further comprising estimating, by the UE, a Doppler frequency offset or a drift rate of a Doppler frequency shift based on relative location information and moving information of the UE and the NT network node.

12. The method of claim 1, wherein the compensating for the frequency shift comprises obtaining, by the UE, relative location information of the UE and the NT network node.

13. The method of claim 12, wherein the obtaining of the relative location information of the UE and the NT network node comprises performing at least one of:
positioning the UE based on a Global Navigation Satellite System (GNSS), a positioning signaling, or a priori setting; and
positioning the NT network node based on an ephemeris or almanac or based on information stored in a memory device.

14. The method of claim 1, wherein the compensating for the frequency shift comprises obtaining by the UE at least one of: information indicating a network type, an elevation angle of the NT network node, a drift rate of a Doppler frequency shift, a common Doppler frequency shift, and an ephemeris.

15. The method of claim 1, wherein the compensating for the frequency shift comprises compensating, by the UE, for a crystal oscillator error by calibrating a crystal oscillator through the TN network or based on a Global Navigation Satellite System (GNSS) clock.

16. An apparatus implementable in a user equipment (UE), comprising:
a transceiver; and
a processor coupled to the transceiver and configured to perform operations comprising:
establishing, via the transceiver, communications with a base station (BS) of a terrestrial network (TN);
establishing, via the transceiver, communications with a non-terrestrial (NT) network node of a non-terrestrial network (NTN); and
compensating for a frequency shift in the communications between the UE and the NTN regardless of availability of information related to a movement of the UE and a relative location of the NT network node with respect to the UE.

17. The apparatus of claim 16, wherein the processor is further configured to perform operations comprising:
compensating for the frequency shift based on at least one of:
performing downlink (DL) or uplink (UL) frequency synchronization; and
performing a frequency tracking.

18. The apparatus of claim 17, wherein the processor is further configured to perform at least one of:
compensating a UL Doppler frequency shift by approximating the UL Doppler frequency shift based on a total DL frequency error;
receiving, via the transceiver, system information from the BS indicating that a common Doppler frequency shift is pre-compensated by the BS or the NT network node, the common Doppler frequency shift including a DL common Doppler frequency shift and a UL common Doppler frequency shift;
performing DL frequency re-synchronization by searching either or both of a primary synchronization signal (PSS) and a secondary synchronization signal (SSS);
tracking a frequency error by using an auto-frequency compensation (AFC) algorithm with a Kalman filter to predict a drift rate of a Doppler frequency shift;
compensating for a Doppler frequency shift based on a duration of a receiver (RX) sleep time and a drift rate of the Doppler frequency shift, with the drift rate of the Doppler frequency shift being broadcasted by the BS in system information;
reserving, via the transceiver, a gap with a duration sufficient for frequency synchronization within a transmission or reception (TX/RX); and
estimating a Doppler frequency offset or a drift rate of a Doppler frequency shift based on relative location information and moving information of the UE and the NT network node.

19. The apparatus of claim 17, wherein the processor is further configured to perform operations comprising:
obtaining, via the transceiver, navigation information of the NT network node by:
obtaining the navigation information using an ephemeris or almanac;
receiving, from the BS or the NT network node, system information containing the navigation information; or
retrieving the navigation information from a memory device; and
compensating for the frequency shift based on the navigation information of the NT network node.

20. The apparatus of claim 16, wherein, in compensating for the frequency shift, the processor is configured to perform at least one of:
obtaining at least one of:
information indicating a network type,
an elevation angle of the NT network node,
a drift rate of a Doppler frequency shift,
a common Doppler frequency shift, and
an ephemeris.
